(19) United States
(12) Patent Application Publication
(10) Pub. No.: US 2022/0194469 A1
(43) Pub. Date: Jun. 23, 2022

(54) AUTONOMOUS VEHICLE STEERING JUKE EVENT DETECTOR

(71) Applicant: Argo AI, LLC, Pittsburgh, PA (US)

(72) Inventors: Ghassan Atmeh, Grosse Pointe Woods, MI (US); Scott Julian Varnhagen, Ann Arbor, MI (US)

(21) Appl. No.: 17/125,484

(22) Filed: Dec. 17, 2020

(51) Int. Cl. B62D 15/02; B60W 60/00

(52) U.S. Cl. CPC B62D 15/021; B60W 2420/52; B60W 60/0015; B60W 60/0011

(57) ABSTRACT

Systems and methods for determining one or more juke events are provided. The method includes generating, for an initial trajectory cycle, an initial planned trajectory of an autonomous vehicle, using a motion planning module, and generating, for a subsequent trajectory cycle, a subsequent planned trajectory of the autonomous vehicle, using the motion planning module. Each of the initial planned trajectory and the subsequent planned trajectory includes a series of planned steering wheel angles over a period of time and a steering wheel angle rate of change over the period of time. The method further includes identifying one or more first juke event qualifiers and one or more second juke event qualifiers, and identifying one or more juke events, wherein each juke event correlates to a time interval at which a first juke event qualifier and a second juke event qualifier occur within a threshold length of time from each other.

### BACKGROUND

### Statement of the Technical Field

The present disclosure relates to juke detection for autonomous vehicles (“AVs”) and, in particular, to detecting juke events using planned trajectory data for an AV.

### Description of the Related Art

AVs use a wide variety of sensors, such as LiDAR and RADAR systems, to perceive the world around them. Sensing algorithms, typically referred to as “perception” algorithms, are developed for AVs in order to process the data received via the sensors and facilitate this perception of the world around them.

AV perception algorithms typically improve over time as they are iterated upon with a variety of different data reflecting various conditions that the AV may perceive. As this improvement happens, small perturbations in perception algorithms can cause less-than-smooth reactions by the motion planning and control part of an AV software stack. One such example is a steering juke event. Such an event can be qualitatively defined as follows: An unexpected large change in the steering wheel angle magnitude in a short period of time, resulting in an undesired maneuver that may or may not result in an operator takeover or degradation in ride quality while the vehicle is in an autonomous mode. For example, a juke event can occur if a perception algorithm forecasts the intent of a pedestrian standing on the sidewalk as wanting to jaywalk, but the pedestrian intends to remain still. A juke event can also occur when smoke or condensation that is sensed by the LiDAR system is classified as an obstacle to the side of the road. Such perception misclassification or noise event can cause the motion planning and control stack to decide to rapidly change a planned road wheel angle action to avoid these obstacles within the planning horizon.

For at least these reasons, systems and methods which identify, detect, and log juke events to enable appropriate updates to improve upon the accuracy of perception algorithms is needed.

### SUMMARY

According to an aspect of the present disclosure, a method for determining one or more juke events is provided. The method includes generating, for an initial trajectory cycle, an initial planned trajectory of an autonomous vehicle, using a motion planning module, and generating, for a subsequent trajectory cycle, a subsequent planned trajectory of the autonomous vehicle, using the motion planning module. Each of the initial planned trajectory and the subsequent planned trajectory includes a series of planned steering wheel angles over a period of time and a steering wheel angle rate of change over the period of time. The method further includes identifying one or more first juke event qualifiers and one or more second juke event qualifiers, and identifying one or more juke events, wherein each juke event correlates to a time interval at which a first juke event qualifier and a second juke event qualifier occur within a threshold length of time from each other. Each first juke event qualifier correlates to a time interval at which the requested steering wheel angle rate of change is greater than a first threshold.

According to various embodiments, the first threshold is dependent from a speed of the autonomous vehicle.

According to various embodiments, each of the initial planned trajectory and the subsequent planned trajectory further include a position and orientation of the autonomous vehicle over the period of time.

According to various embodiments, generating the subsequent planned trajectory further includes analyzing data collected from one or more perception sensors coupled to the autonomous vehicle, and identifying, from the analyzed data, one or more obstacles present along the initial planned trajectory. The subsequent planned trajectory is configured to enable the autonomous vehicle to avoid each of the one or more obstacles.

According to various embodiments, the method further includes calculating, for each time interval during the period of time, a maximum ratio between the steering wheel angle rate of change for the initial planned trajectory and the subsequent planned trajectory. Each second juke event qualifier correlates to a time interval at which the maximum ratio is greater than a second threshold.

According to various embodiments, the second threshold is dependent from a speed of the autonomous vehicle.

According to various embodiments, the initial trajectory cycle and the subsequent trajectory cycle are consecutive trajectory cycles.

According to another aspect of the present disclosure, a system for determining one or more juke events is provided. The system includes an autonomous vehicle and a computing device of the autonomous vehicle. The computing device includes a processor and a memory. The memory includes instructions that are configured to cause the computing device to generate, for an initial trajectory cycle, an initial planned trajectory of an autonomous vehicle, using a motion planning module, and generate, for a subsequent trajectory cycle, a subsequent planned trajectory of the autonomous vehicle, using the motion planning module. Each of the initial planned trajectory and the subsequent planned trajectory includes a series of planned steering wheel angles over a period of time and a steering wheel angle rate of change over the period of time. The instructions are further configured to cause the computing device to identify one or more first juke event qualifiers, identify one or more second juke event qualifiers, and identify one or more juke events, wherein each juke event correlates to a time interval at which a first juke event qualifier and a second juke event qualifier occur within a threshold length of time from each other. Each first juke event qualifier correlates to a time interval at which the steering wheel angle rate of change is greater than a first threshold.

According to various embodiments, each of the initial planned trajectory and the subsequent planned trajectory further include a position and orientation of the autonomous vehicle over the period of time.

According to various embodiments, generating the subsequent planned trajectory further includes analyzing data collected from one or more perception sensors coupled to the autonomous vehicle, and identifying, from the analyzed data, one or more obstacles present along the initial planned trajectory. The subsequent planned trajectory is configured to enable the autonomous vehicle to avoid each of the one or more obstacles.

According to various embodiments, the first threshold is dependent from a speed of the autonomous vehicle.

According to various embodiments, the instructions are further configured to cause the computing device to calculate, for each time interval during the period of time, a maximum ratio between the steering wheel angle rate of change for the initial planned trajectory and the subsequent planned trajectory. Each second juke event qualifier correlates to a time interval at which the maximum ratio is greater than a second threshold.

According to various embodiments, the second threshold is dependent from a speed of the autonomous vehicle.

According to various embodiments, the initial trajectory cycle and the subsequent trajectory cycle are consecutive trajectory cycles.

### BRIEF DESCRIPTION OF THE DRAWINGS

FIG. 1 is an example of a juke detection system, in accordance with various embodiments of the present disclosure.

FIG. 2A is an example of a graphical representation of a planned steering wheel angle (“SWA”), in accordance with the present disclosure.

FIG. 2B is an example of a graphical representation of a planned SWA rate, in accordance with the present disclosure.

FIG. 3 is an example of a graphical representation of a spike in a requested SWA rate, in accordance with the present disclosure.

FIG. 4A is an example of a graphical representation of a planned SWA rate, in accordance with the present disclosure.

FIG. 4B is an example of a graphical representation of a spike in a planned SWA rate, in accordance with the present disclosure.

FIG. 5 is a flowchart of a method for detecting juke events, in accordance with the present disclosure.

FIG. 6 is an illustration of an illustrative computing device, in accordance with the present disclosure.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.” Definitions for additional terms that are relevant to this document are included at the end of this Detailed Description.

An “electronic device” or a “computing device” refers to a device that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions.

The terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices.

The terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process.

The term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones and the like. An “autonomous vehicle” is a vehicle having a processor, programming instructions and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle's autonomous system and may take control of the vehicle.

In this document, when terms such as “first” and “second” are used to modify a noun, such use is simply intended to distinguish one item from another, and is not intended to require a sequential order unless specifically stated. In addition, terms of relative position such as “vertical” and “horizontal”, or “front” and “rear”, when used, are intended to be relative to each other and need not be absolute, and only refer to one possible position of the device associated with those terms depending on the device's orientation.

A “trajectory” that an autonomous vehicle (“AV”) generates for itself is the plan that the vehicle will follow when controlling its motion. The trajectory includes the AV's position and orientation over a time horizon, as well as the AV's planned steering wheel angle (“SWA”) and angle rate over the same time horizon. The AV's motion control system will consume the trajectory and send commands to the AV's steering control system, brake controller, throttle, and/or other system controllers to move the AV along the planned path.

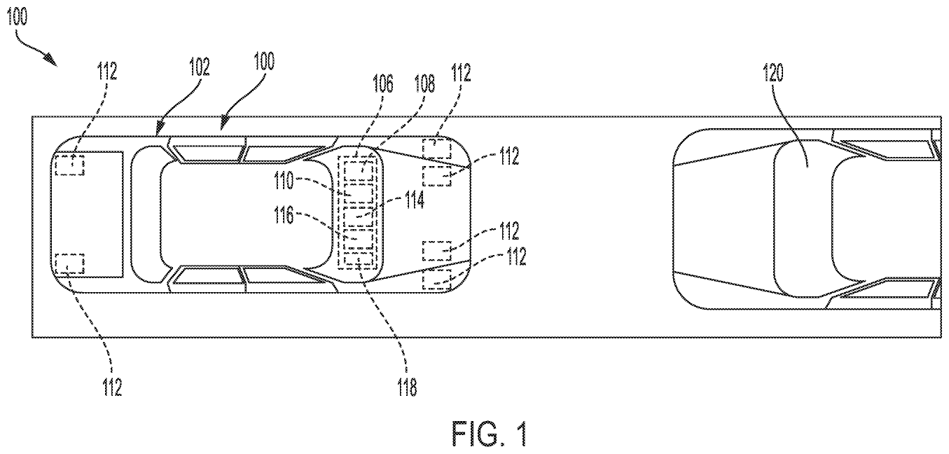

Referring now to FIG. 1, an example of a juke detection system 100 is provided, in accordance with various embodiments of the present disclosure.

According to various embodiments, the system 100 includes an autonomous vehicle 102, which includes one or more AV motion control sensors 104 configured to detect one or more trajectory data points of the AV 102, such as “SWA values, road wheel angle values, speed, and/or other suitable data points.

The system 100 includes one or more computing devices 106. The one or more computing devices 106 can be coupled and/or integrated with the AV 102 and/or remote from the AV 102.

The one or more computing devices 106 include a motion planning module 108. The motion planning module 108 includes software and/or hardware components and is configured to generate one or more plans, also referred to as planned trajectories, for the movement of the AV 102. Each of the planned trajectories includes information such as the AV's 102 position and orientation for a period of time (called the “horizon”). For example, each of the planned trajectories includes information the AV 102 for the next n-seconds and/or other suitable time interval.

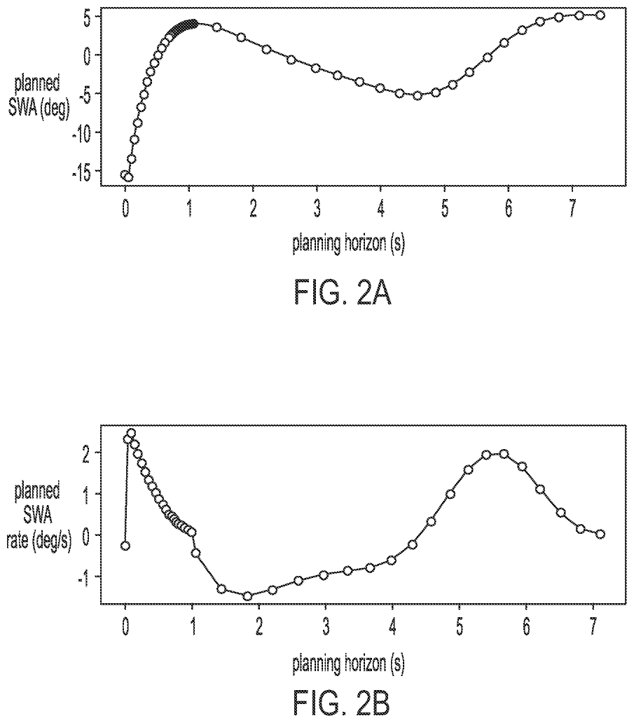

Each of the planned trajectories further includes the AV's 102 planned SWA, SWA rate of change over the horizon, and/or other suitable data points such as, for example, road wheel angle and road wheel angle rate of change over the horizon. For example, a planned SWA (measured in degrees) from a planned trajectory is shown in FIG. 2A, and a planned SWA rate of change (measured in degrees/second) for a planned trajectory, is shown in FIG. 2B. The planned SWA of FIG. 2A and the planned SWA rate of FIG. 2B are illustrated for a planned trajectory having a 7 second horizon. Other suitable lengths of time for the horizon can be implemented according to various embodiments of the present disclosure.

The one or more computing devices 106 include a motion control module 110 configured to implement the planned trajectory generated by the motion planning module 108. The motion control module 110 includes software and/or hardware components and, according to various embodiments, is configured to generate one or more commands for controlling movement of the AV 102 based on the planned trajectory. The motion control module 110 further acts as a steering control module configured to control the steering of the AV 102. The commands include SWA requests for the AV platform steering control module.

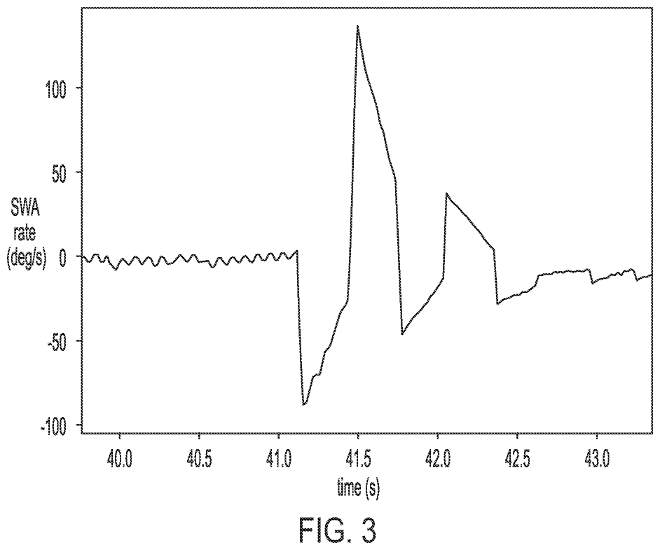

The motion planning module 108 is configured to generate planned trajectories for each of a series of trajectory cycles. For example, the motion planning module 108 can generate an initial planned trajectory for a first trajectory cycle over a horizon and one or more subsequent planned trajectories over the horizon. Consecutive planned trajectories that have vastly different planned SWAs could cause a large jump between two consecutive SWA requests sent by the motion control module 110 to the AV 102, which can cause a spike in the requested SWA rate of change over the horizon. Such a spike is illustratively depicted in FIG. 3.

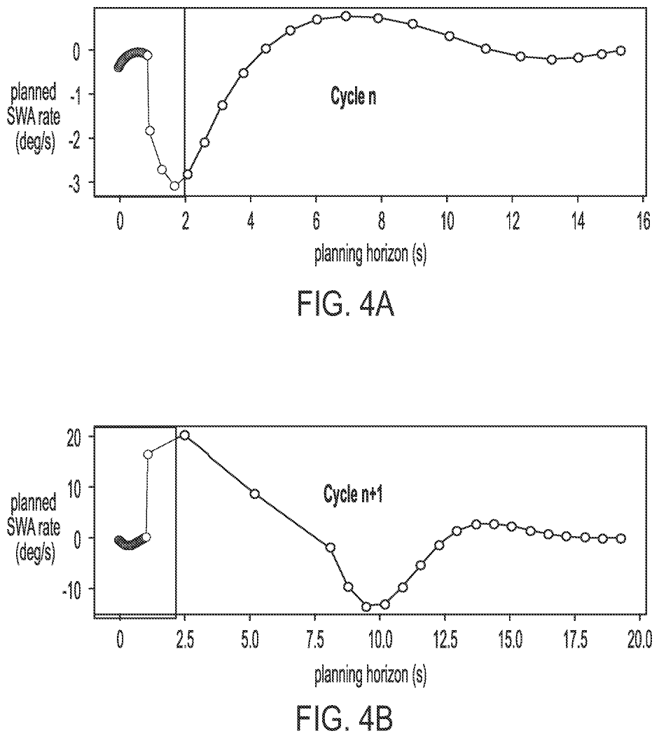

According to various embodiments, the AV 102 includes one or more perception sensors 112 such as, for example, one or more cameras, LIDAR assemblies, RADAR assemblies, one or more audio recording devices, and/or other suitable perception sensors 112. The one or more perception sensors 112 are configured to collect perception data pertaining to one or more objects and/or obstacles along a planned trajectory. The obstacles may include, for example, vehicles 120, pedestrians, debris, animals, and/or other suitable obstacles. The one or more computing devices 106 can include an object detection module 114 configured to analyze the perception data from the one or more perception sensors 112 in order to determine whether one or more objects pose obstacles in positioned along the planned trajectory of the AV 102. However, some objects labeled as obstacles by the object detection module 114 may be falsely detected. For example, if a vehicle is traveling in a relatively straight line and a cloud of condensation from an exhaust pipe of a vehicle next to the AV 102 is false positively detected as an obstacle by the object detection module 114, a change of the planned SWA from straight-line driving (approximately zero degrees over the horizon) to a quick swerve trajectory that has relatively large SWA values results. This would cause a significantly large jump in the planned SWA rate between trajectory cycles. Such a jump between trajectory cycles is illustrated in FIG. 4A, at cycle n, and FIG. 4B, at cycle n+1.

According to various embodiments, the planned trajectory data is used to determine one or more juke events. A juke event is defined as an event that occurs when a first juke event qualifier and/or a second juke event qualifier is met. According to an exemplary embodiment, the juke event occurs when, (1) over a threshold time window, (2) a requested SWA rate of change is greater than a first speed dependent threshold (a first juke event qualifier), and (3) a maximum ratio between the SWA rate of change for the initial planned trajectory and a subsequent, and consecutive, planned trajectory is greater than a second speed dependent threshold (a second juke event qualifier). According to some embodiments, the threshold time window is 1 second or shorter.

The one or more computing devices 106 include a juke detecting module 116 configured to detect one or more juke events. According to various embodiments, the juke detecting module 116 includes a processor and a memory and is configured to store a buffer for the SWA request rate of change and the maximum planned SWA rate of change ratio between consecutive trajectory cycles. According to various embodiments, the buffer is continuously monitored to determine when the criteria for a juke event have been met. According to various embodiments, the one or more computing devices 106 include a hysteresis timer 118 which is configured to avoid double-counting of a juke event.

According to various embodiments, when a juke event is detected, a diagnostic signal is generated by the juke detecting module 116 to be logged by an onboard logger. According to various embodiments, the juke detecting module 116 further publishes metadata, such as an approximate time of the juke event as well as a severity level of the juke event.

An example algorithmic process for detecting juke events onboard an AV 102 is shown in Table 1.

```
TABLE 1
Initialize max planned SWA ratio buffer [symbol]
Initialize SWA request rate buffer \dot{δ}_{req}
Initialize double hysteresis_timer to n seconds
Initialize double threshold_1 for max planned SWA ratio
used to check \dot{δ}_{req}
Initialize double threshold_2 for SWA request rate used to
check [symbol]
Initialize vehicle_speed
while AV is engaged in auto:
  if new trajectory message is received:
    update m second history of Δ_{δmax}
  if new vehicle_actuation message is received:
    update m second history of \dot{δ}_{req}
  if new motion_state message is received:
    update vehicle_speed
  decrement hysteresis_timer by elapsed time as needed
  if hysteresis_timer is ZERO:
    use vehicle speed to update threshold_1
    if any entry in m second history \dot{δ}_{req} > threshold_1:
      && any entry in m second history of Δ_{δmax} > threshold_2:
        send juke annotation
        increment juke counters diagnostics
        reset hysteresis_timer to n seconds
```

A juke event serves as an indication of a lateral ride quality of the AV 102. Previous work related to ride quality has been typically focused on using inertial measurements from the AV 102, such as lateral acceleration, to quantify ride quality. These methods, however, do not capture all of the juke-type events that occur. This is especially true for AVs 102 in a test fleet that are operated by test specialists who are trained to take over in the event of an unwanted or unsafe event, such as a juke event. In many cases, when the operator takes over the manual operation of an AV 102 during a juke event, the operator does so by reacting to the steering wheel motion and holding on tightly to the steering wheel. This action suppresses the juke event before the juke event registers a lateral acceleration in the vehicle motion. The reason for this is that, due to vehicle inertia, there is a lag between when the steering moves and when the AV 102 actually starts turning. Therefore, if a juke detector relied upon lateral acceleration in determining an occurrence of a juke event, many of the juke events that occur during a takeover by an operator would be missed.

By analyzing the SWA rate of change rather than the lateral acceleration, the present system 100 improves upon the existing methods and technologies by detecting juke events prior to, or irrespective of, lateral acceleration of the AV 102, thus increasing the accuracy of juke detection.

Additionally, the SWA rate of change for a planned trajectory for a singular trajectory cycle merely indicates how fast the motion control module 110 is requesting the steering wheel of the AV 102 to be turned and not if the SWA rate of change was due to a sudden perception event. Also, when driving in urban environments, as do many AVs 102, some tight corners require very high SWA request rates. It would be undesirable to register those as false positive jukes. By combining the SWA request rate of change feature with the maximum planned SWA rate of change ratio between consecutive trajectories, the confidence that the event being detected is due to the AV 102 drastically changing its trajectory between two consecutive cycles is increased, decreasing false positives, thus increasing ride safety and ride enjoyment/satisfaction.

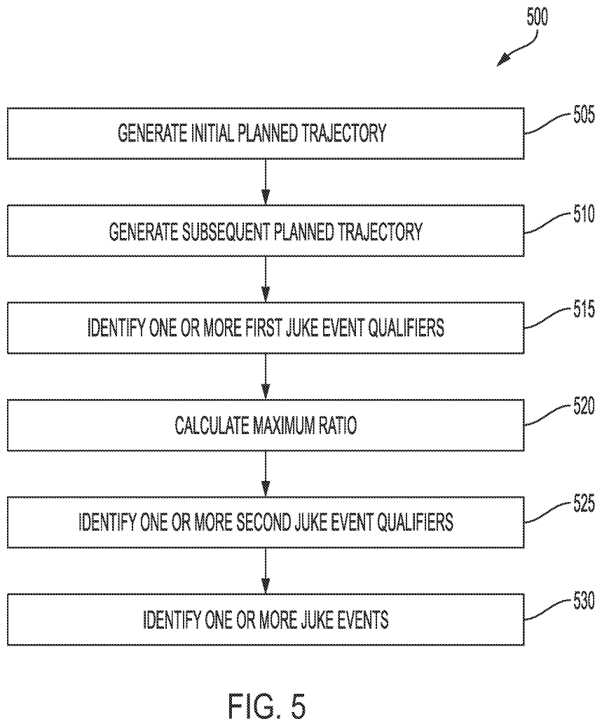

Referring now to FIG. 5, a flowchart of a method 500 for detecting one or more juke events is illustratively depicted.

According to various embodiments, at 505, an initial planned trajectory of an AV is generated, for an initial trajectory cycle, using a motion planning module electronically coupled to the AV and, at 510, a subsequent planned trajectory of the AV is generated, for a subsequent trajectory cycle, using the motion planning module electronically coupled to the AV. Each of the planned trajectories (the initial planned trajectory and the subsequent planned trajectory) includes a series of planned SWAs over a period of time (also referred to as the horizon), a steering wheel angle rate of change over that period of time, and a position and orientation of the AV over the period of time. The initial trajectory cycle and the subsequent trajectory cycle are consecutive trajectory cycles.

According to various embodiments, generating the subsequent planned trajectory further includes analyzing data collected from one or more perception sensors coupled to the autonomous vehicle, and identifying, from the analyzed data, one or more obstacles present along the initial planned trajectory. The subsequent planned trajectory is configured to enable the autonomous vehicle to avoid each of the one or more obstacles.

At 515, one or more first juke event qualifiers are identified. Each of the one or more first juke event qualifiers correlates to a time interval at which the requested SWA rate of change is greater than a first threshold. According to various embodiments, the first threshold is speed-dependent (i.e., dependent from a speed of the AV). According to various embodiments, the first threshold is determined from human annotated data from an AV test fleet. The test specialists operating the AVs in the test fleet may annotate events that they consider to be juke events. Such annotations are mined from AV test fleet logs for a requested SWA rate and vehicle speed at the time of each of the juke events and the first threshold is based on this data. It is noted, however, that other suitable means for determining the first threshold may be used, in accordance with various embodiments of the present invention.

At 520, for each time interval during the period of time, a maximum ratio between the steering wheel angle rate of change for the initial planned trajectory and the subsequent planned trajectory is calculated. This maximum ratio, at 525, is used to identify one or more second juke event qualifiers. Each of the one or more second juke event qualifiers correlates to a time interval at which the maximum ratio is greater than a second threshold. According to various embodiments, the second threshold is speed-dependent.

Using the one or more first juke event qualifiers and the one or more second juke event qualifiers, one or more juke events, at 530, are identified. Each juke event correlates to a time interval at which a first juke event qualifier and/or a second juke event qualifier occur within a threshold length of time from each other. According to some embodiments, the threshold length of time is one second or shorter.

According to various embodiment, a series of measured SWA values during the period of time are measured using one or more AV motion control sensors coupled to the AV. The one or more motion control sensors are configured to detect one or more trajectory data points of the AV. The one or more trajectory data points can include the measured SWA values. According to some embodiments, the series of measured SWA values are measured over one or more time intervals at which the AV is in an autonomous mode (i.e., being automatically driven and not controlled by a user). According to various embodiments, the system is configured to determine when the AV is in an autonomous mode and when the AV is controlled by a user. The series of measured SWA values are compared against the series of planned SWAs of the first planned trajectory in order to validate the juke detection system.

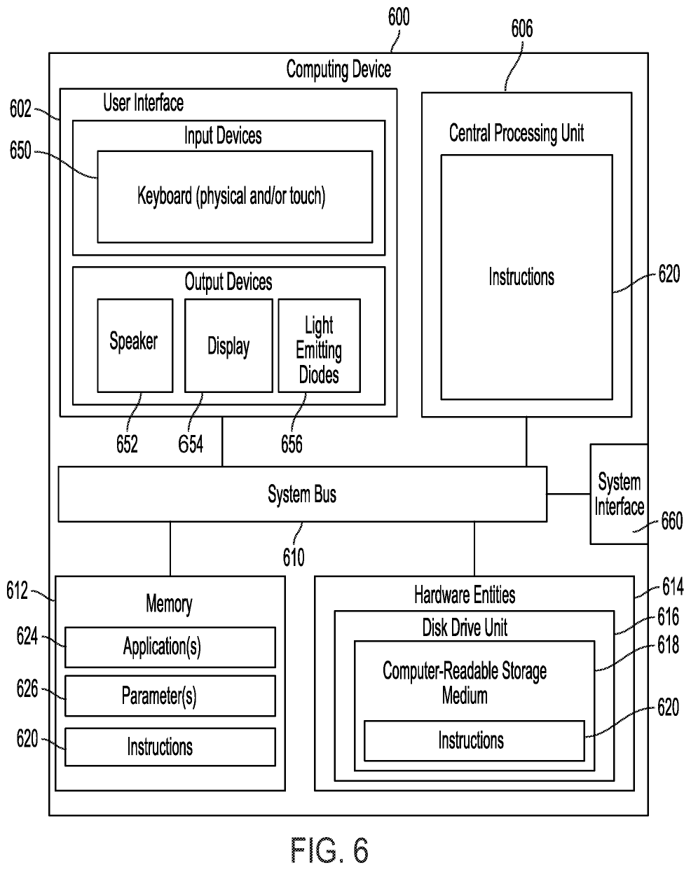

Referring now to FIG. 6, an illustration of an illustrative architecture for a computing device 600 is provided. The computing device 106 of FIG. 1 is the same as or similar to computing device 600. As such, the discussion of computing device 600 is sufficient for understanding the computing device 106 of FIG. 1.

Computing device 600 may include more or less components than those shown in FIG. 6. However, the components shown are sufficient to disclose an illustrative solution implementing the present solution. The hardware architecture of FIG. 6 represents one implementation of a representative computing device configured to one or more juke events, as described herein. As such, the computing device 600 of FIG. 6 implements at least a portion of the method(s) described herein.

Some or all components of the computing device 600 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 6, the computing device 600 comprises a user interface 602, a Central Processing Unit (“CPU”) 606, a system bus 610, a memory 612 connected to and accessible by other portions of computing device 600 through system bus 610, a system interface 660, and hardware entities 614 connected to system bus 610. The user interface can include input devices and output devices, which facilitate user-software interactions for controlling operations of the computing device 600. The input devices include, but are not limited to, a physical and/or touch keyboard 650. The input devices can be connected to the computing device 600 via a wired or wireless connection (e.g., a Bluetooth® connection). The output devices include, but are not limited to, a speaker 652, a display 654, and/or light emitting diodes 656. System interface 660 is configured to facilitate wired or wireless communications to and from external devices (e.g., network nodes such as access points, etc.).

At least some of the hardware entities 614 perform actions involving access to and use of memory 612, which can be a random access memory (“RAM”), a disk drive, flash memory, a compact disc read only memory (“CD-ROM”) and/or another hardware device that is capable of storing instructions and data. Hardware entities 614 can include a disk drive unit 616 comprising a computer-readable storage medium 618 on which is stored one or more sets of instructions 620 (e.g., software code) configured to implement one or more of the methodologies, procedures, or functions described herein. The instructions 620 can also reside, completely or at least partially, within the memory 612 and/or within the CPU 606 during execution thereof by the computing device 600. The memory 612 and the CPU 606 also can constitute machine-readable media. The term “machine-readable media”, as used here, refers to a single medium or multiple media (e.g., a centralized or distributed database, and/or associated caches and servers) that store the one or more sets of instructions 620. The term “machine-readable media”, as used here, also refers to any medium that is capable of storing, encoding or carrying a set of instructions 620 for execution by the computing device 600 and that cause the computing device 600 to perform any one or more of the methodologies of the present disclosure.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

What is claimed is:

1. A method for determining one or more juke events, the method comprising:
generating, for an initial trajectory cycle, an initial planned trajectory of an autonomous vehicle, using a motion planning module;
generating, for a subsequent trajectory cycle, a subsequent planned trajectory of the autonomous vehicle, using the motion planning module,
wherein each of the initial planned trajectory and the subsequent planned trajectory includes a series of planned steering wheel angles over a period of time and a steering wheel angle rate of change over the period of time;
identifying one or more first juke event qualifiers, wherein each first juke event qualifier correlates to a time interval at which the requested steering wheel angle rate of change is greater than a first threshold;
identifying one or more second juke event qualifiers; and
identifying one or more juke events, wherein each juke event correlates to a time interval at which a first juke event qualifier and a second juke event qualifier occur within a threshold length of time from each other.

2. The method of claim 1, wherein each of the initial planned trajectory and the subsequent planned trajectory further include a position and orientation of the autonomous vehicle over the period of time.

3. The method of claim 2, wherein generating the subsequent planned trajectory further comprises:
analyzing data collected from one or more perception sensors coupled to the autonomous vehicle; and
identifying, from the analyzed data, one or more obstacles present along the initial planned trajectory,
wherein the subsequent planned trajectory is configured to enable the autonomous vehicle to avoid each of the one or more obstacles.

4. The method of claim 1, wherein the first threshold is dependent from a speed of the autonomous vehicle.

5. The method of claim 1, further comprising:
calculating, for each time interval during the period of time, a maximum ratio between the steering wheel angle rate of change for the initial planned trajectory and the subsequent planned trajectory,
wherein each second juke event qualifier correlates to a time interval at which the maximum ratio is greater than a second threshold.

6. The method of claim 5, wherein the second threshold is dependent from a speed of the autonomous vehicle.

7. The method of claim 1, wherein the initial trajectory cycle and the subsequent trajectory cycle are consecutive trajectory cycles.

8. A system for determining one or more juke events, the system comprising:
an autonomous vehicle; and
a computing device of the autonomous vehicle, including:
a processor; and
a memory that includes instructions that are configured to cause the computing device to:
generate, for an initial trajectory cycle, an initial planned trajectory of an autonomous vehicle, using a motion planning module;
generate, for a subsequent trajectory cycle, a subsequent planned trajectory of the autonomous vehicle, using the motion planning module,
wherein each of the initial planned trajectory and the subsequent planned trajectory includes a series of planned steering wheel angles over a period of time and a steering wheel angle rate of change over the period of time;
identify one or more first juke event qualifiers, wherein each first juke event qualifier correlates to a time interval at which the steering wheel angle rate of change is greater than a first threshold;
identify one or more second juke event qualifiers; and
identify one or more juke events, wherein each juke event correlates to a time interval at which a first juke event qualifier and a second juke event qualifier occur within a threshold length of time from each other.

9. The system of claim 8, wherein each of the initial planned trajectory and the subsequent planned trajectory further include a position and orientation of the autonomous vehicle over the period of time.

10. The system of claim 9, wherein generating the subsequent planned trajectory further comprises:
analyzing data collected from one or more perception sensors coupled to the autonomous vehicle; and
identifying, from the analyzed data, one or more obstacles present along the initial planned trajectory,
wherein the subsequent planned trajectory is configured to enable the autonomous vehicle to avoid each of the one or more obstacles.

11. The system of claim 8, wherein the first threshold is dependent from a speed of the autonomous vehicle.

12. The system of claim 8, wherein the instructions are further configured to cause the computing device to calculate, for each time interval during the period of time, a maximum ratio between the steering wheel angle rate of change for the initial planned trajectory and the subsequent planned trajectory,
wherein each second juke event qualifier correlates to a time interval at which the maximum ratio is greater than a second threshold.

13. The system of claim 12, wherein the second threshold is dependent from a speed of the autonomous vehicle.

14. The system of claim 8, wherein the initial trajectory cycle and the subsequent trajectory cycle are consecutive trajectory cycles.
